(19) United States
(12) Patent Application Publication
(10) Pub. No.: US 2021/0347129 A1
(43) Pub. Date: Nov. 11, 2021

(54) Plastic container with mounting part

(71) Applicant: MAGNA Energy Storage Systems GesmbH, Sinabelkirchen (AT)

(72) Inventors: Thomas FUCHS, Sinabelkirchen (AT); Andreas PREITLER, Gratkorn (AT); Rainer PUCHLEITNER, Graz (AT)

(21) Appl. No.: 17/307,023

(22) Filed: May 4, 2021

(30) Foreign Application Priority Data
May 7, 2020 (EP) EP20173362.3
May 19, 2020 (EP) EP20175384.5

(51) Int. Cl. B29C 65/00; B60K 15/03

(52) U.S. Cl. CPC B29C 66/30321; B29L 2031/7172; B60K 15/03177; B29C 66/0242

(57) ABSTRACT

A method for producing a plastic container, and a plastic container. The method includes heating a container wall of the plastic container at least in a fastening region thereof, and then producing a form-fit connection between the container wall and at least one insert having a fastening surface with a plurality of retaining geometries which protrude from the fastening surface. The form-fit connection is produced by pressing the fastening surface of the insert part against the heated fastening region of the container wall such that the retaining geometries penetrate into the container wall without penetrating through the container wall, free ends of the retaining geometries come to lie inside the container wall, and the plastic of the container wall is arranged between the retaining geometries.

### CROSS-REFERENCE TO RELATED APPLICATIONS

The present application claims priority 35 U.S.C. § 119 to European Patent Application Nos. EP 20173362.3 (filed on May 7, 2020) and EP 20175384.5 (filed on May 19, 2020), which are hereby incorporated by reference in their respective entireties.

### TECHNICAL FIELD

One or more embodiments relate to a method for producing a plastic container, at least one insert part being fastened to the container wall of the plastic container, and to such a plastic container.

### BACKGROUND

The production of containers, in particular, tanks for motor vehicles such as, for example, fuel tanks, from plastic, for example from high density polyethylene (HDPE) is known. The production may be carried out, for example, by blow moulding or deep drawing. The container walls of such fuel tanks of plastic may contain a barrier layer, for example of ethylene vinyl alcohol copolymer (EVOH), for reducing undesired hydrocarbon emissions.

The fastening of components in and to plastic tanks is also known. In particular, insert parts may be fastened in a materially bonded manner to a heated container wall by welding in the course of the production of the plastic tank.

Insert and/or attachment parts are also welded in and to the container via cold and hot welding processes by using additional components, what are known as “weld crowns”, which are clipped together or conjointly injection moulded using 2-component technology and are composed of the same material from which the plastic container is produced.

Moreover, methods exist which produce a type of rivet connection, in that the heated soft material of the container penetrates through an opening in the component to be welded during the joining process and the soft material is caulked on the side facing outwards via a stamping die. Here, the material of the component to be applied does not have to correspond to the material of the plastic container. The blow-moulded part may be a plastic fuel container, but also any other component which is produced from a thermoplastic.

In the current prior art, a plurality of aspects and boundary conditions for a suitable welding have to be provided for the attachment of components by welding. In the case of the attachment of a preheated welded-on part into the still-hot sheet material, the heat penetration zone has to be taken into consideration in order not to damage the multilayer composite. A complex calibration of the process is usually necessary. In particular, for the attachment of valves, a certain spacing, which can amount to several millimetres, is also required for the weld crown. This is a significant technical disadvantage for a multiplicity of tank projects.

In the case of hot caulking, installation space has to be kept available around the actual component for the attachment tabs, which leads to compromises in terms of the design of the tank system and can be considered to be a significant technical disadvantage.

### SUMMARY

One or more embodiments disclosed herein intends to dispense with on the one hand a component additionally required for welding components to or in the plastic container that has to be composed of the same material as the plastic container, and on the other hand the necessary installation space and/or necessary surfaces required for a hot caulking process with components of a different material.

Consequently, the intention is that components which may comprise a material which does not correspond to the blow-moulded part may be applied directly to or in the blow-moulded part, without requiring additional tools and components.

One or more embodiments is to specify a method for producing a plastic container which avoids the above-mentioned problems. In particular, one or more embodiments is to specify a simple and cost-effective procedure for attaching an insert part in a plastic container, in a manner where as little as possible installation space is lost and it is also possible for the insert part to comprise a different material than the container wall.

One or more embodiments is to further specify a plastic container which comprises a reliably fastened insert part and can be produced in the simple way specified in the process.

In accordance with one or more embodiments, a method for producing a plastic container comprising a container wall and at least one insert part to the container wall, the insert part having a fastening surface with a plurality of retaining geometries or structures which protrude from the fastening surface, the method comprising the following: heating the container wall at least in a fastening region; pressing the fastening surface of the insert part against the heated fastening region of the container wall in order that the retaining geometries penetrate into the container wall without penetrating completely through the container wall and free ends of the retaining geometries come to lie inside the container wall, the plastic of the container wall coming to lie between the retaining geometries, with the result that a form-fit exists between the retaining geometries of the insert part and the plastic of the container wall.

In accordance with one or more embodiments, an insert part is used which has a plurality of retaining geometries on a fastening surface.

In accordance with one or more embodiments, the retaining geometries or structures are pressed into a hot, soft container wall of plastic. The container wall may be heated in the course of the production process of the container, for example, in particular, as a result of the heating when the container is being shaped, or may be heated in a separate process after the production of the container. The retaining geometries are pressed into the container wall with such a force that the retaining geometries pass into the container wall, but do not penetrate completely through the container wall, and therefore, do not destroy the container wall. The “free ends” of the retaining geometries, i.e., the ends of the retaining geometries facing away from the fastening surface, do not penetrate through the container wall. In this way, the retaining geometries are retained by the plastic of the container wall in a simple manner, without weakening the container wall.

A connection of this type may also be produced with insert parts of a different material than that of the container wall. The insert parts may thus also comprise a different plastic than the container wall, or of metal, for example. The connection is achieved by a simple pushing-in operation and can therefore be carried out cost-effectively. A reliable retention of the insert parts is achieved by the use of a plurality of retaining geometries of this type.

It is preferably the case that the retaining geometries or structures form undercuts and/or the retaining geometries comprise form-fitting elements. The retaining geometries may comprise surfaces which are substantially in the form of undercuts with respect to the joining direction, for example. A particularly secure retention of the insert parts in the possible loading directions is achieved by such retaining geometries with undercuts and/or form-fitting elements.

The retaining geometries or structures may be formed such that heads of the retaining geometries are respectively connected to the fastening surface via feet of the retaining geometries, which feet have a smaller cross-section than the heads of the retaining geometries. In particular, the retaining geometries or structures may have a mushroom-like form.

In accordance with one or more embodiments, the fastening surface of the insert part may be pressed against the heated fastening region of the container wall such that the heads of the retaining geometries penetrate into the container wall and come to lie inside the container wall, the plastic of the container wall coming to lie behind the heads, acting as an undercut, between the feet of the retaining geometries, and therefore, a form-fit exists between the retaining geometries or structures of the insert part and the plastic of the container wall. In that case, the retaining geometries or structures thus have a cross-section in which an undercut head is wider than foot parts which connect this head to the fastening surface. Retaining geometries of this type are pressed into the hot, soft container wall of plastic. The retaining geometries or structures are pressed into the container wall with such a force that the heads and, at least in certain portions, the feet of the retaining geometries or structures pass into the container wall, but do not penetrate through the container wall and therefore do not destroy it. In this way, a form-fitting connection between the plastic of the container wall and the retaining geometries or structures of the insert part is produced behind the heads of the retaining geometries.

In accordance with one or more embodiments, the retaining geometries or structures may be in the form of oblique ribs, i.e., protruding surfaces which are inclined at an angle with respect to the fastening surface. The retaining geometries or structures may also be in the form of arcs, elbows, hooks, or other undercut geometries. The retaining geometries or structures may, as seen in the direction of the fastening surface, for example, form rectangles or mutually parallel lines, specifically by way of mutually parallel surfaces. The retaining geometries or structures may also be formed by any desired combinations of the geometries stated.

In accordance with one or more embodiments, the retaining geometries or structures preferably extend linearly in a direction which is normal to an oblique, arcuate, angled, hook-shaped, mushroom-shaped, or other undercut cross-section, it preferably being the case that a plurality of linear retaining geometries or structures are arranged next to one another in parallel.

In accordance with one or more embodiments, the container wall preferably has a barrier layer in the fastening region. In that case, the fastening surface of the insert part is preferably pressed against the heated fastening region of the container wall, such that the retaining geometries or structures come to lie in front of the barrier layer, i.e., do not penetrate through the barrier layer. The barrier layer thus remains intact in a connection process of this kind, and therefore, the emission characteristics of the container are improved in comparison with other fastening processes, for example, via connecting elements which penetrate through the container in a groove-like manner.

The fastening surface of the insert part is pressed against the heated fastening region of the container wall preferably such that the fastening surface of the insert part lies against the fastening region of the container wall.

The fastening surface of the insert part is preferably formed over the entire surface area, and therefore, does not have any openings. The plastic may thus fill closed spaces between the feet of the retaining geometries, with the result that a particularly good form-fitting retention is produced. Moreover, with a closed fastening surface, it is more easily possible to press the insert part only as far as necessary into the container wall and thus not to damage the container wall and possibly the barrier layer.

In accordance with one or more embodiments, a plastic container thus comprises a container wall and at least one insert part which is fastened to the container wall. The insert part has a fastening surface with a plurality of retaining geometries or structures protruding from the fastening surface. The fastening surface of the insert part is fastened to a fastening region of the container wall with the result that the retaining geometries or structures have penetrated into the container wall and lie inside the container wall without penetrating through the container wall. The plastic of the container wall thus lays between the retaining geometries or structures with the result that a form-fit exists between the retaining geometries or structures of the insert part and the plastic of the container wall. This form-fit is produced preferably exclusively by pressing the retaining geometry into the container wall without an additional, shaping operation.

The retaining geometries or structures preferably form undercuts and/or comprise form-fitting elements.

The retaining geometries or structures may also be in the form of oblique ribs, arcs, elbows or hooks and/or comprise other form-fitting elements or undercuts.

The cross-sections of the retaining geometries or structures may be formed such that heads of the retaining geometries or structures are respectively connected to the fastening surface, in particular in a mushroom-shaped manner, via feet of the retaining geometries, which feet have a smaller cross-section than the heads of the retaining geometries. The plastic of the container wall may lie behind the elements of the retaining geometries or structures that act as an undercut, for example behind heads, which lie between the feet of the retaining geometries, and therefore a form-fit exists between the retaining geometries or structures of the insert part and the plastic of the container wall.

The retaining geometries or structures may have a pointed configuration on their surface which faces the container, for example, in order to penetrate into the container wall more easily, and/or may have a flat form on their side which faces away from the container or may be inclined towards the insert part concavely or outwardly, in order to achieve a better form-fit and/or a better undercut.

The retaining geometries or structures preferably extend linearly, in a direction which is normal to the cross-section, in particular to the oblique, arcuate, angled, hook-shaped, mushroom-shaped or rectangular cross-section, it being particularly preferable that a plurality of linear retaining geometries or structures is arranged next to one another in parallel.

The container wall preferably has a barrier layer in the fastening region and the retaining geometries or structures lie in front of the barrier layer, that is to say do not penetrate through the barrier layer.

The fastening surface of the insert part preferably lies against the fastening region of the container wall.

The fastening surface of the insert part is preferably formed over the entire surface area, that is to say does not have any openings.

### DRAWINGS

One or more embodiments will be illustrated by way of example in the drawings and explained in the description hereinbelow.

FIG. 1 illustrates a three-dimensional view of the fastening surface of an insert part of a plastic container, in accordance with one or more embodiments.

FIG. 2 illustrates a sectional view of the region of the connection between the insert part and the container wall of a plastic container, in accordance with one or more embodiments.

### DESCRIPTION

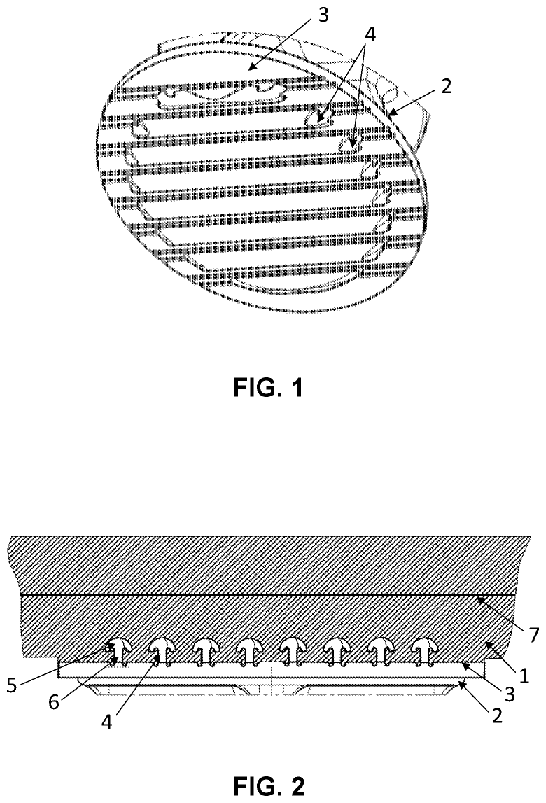

FIG. 1 illustrates the fastening surface 3 of an insert part 2 of a plastic container in accordance with one or more embodiments. The cross-section of the fastening surface 3 of the insert part 2 has undercut retaining geometries or structures 4 which extend linearly along the fastening surface 3 in a plurality of mutually parallel paths. The fastening surface 3 is formed to be pressed into a heated container wall 1 of a plastic container, the retaining geometries or structures 4 catching in the plastic of the container wall 1.

As illustrated in FIG. 2, an insert part 2 is fastened in the container wall 1 of a plastic container, for example a fuel tank. The insert part 2 has a fastening surface 3 with a plurality of retaining geometries or structures 4 which are undercut, i.e., mushroom-shaped, in cross-section. Therefore, heads 5 of the retaining geometries or structures 4 are respectively connected to the fastening surface 3 via feet 6 of the retaining geometries or structures 4, which feet have a smaller cross-section than the heads 5 of the retaining geometries or structures 4. The fastening surface 3 of the insert part 2 is fastened to a fastening region of the container wall 1 such that the heads 5 of the retaining geometries or structures 4 have penetrated into the container wall 1 and lie inside the container wall 1 without penetrating through the container wall. The plastic of the container wall 1 lays behind the heads 5, acting as an undercut, between the feet 6 of the retaining geometries or structures 4, and therefore, a form-fit exists between the retaining geometries or structures 4 of the insert part 2 and the plastic of the container wall 1.

The retaining geometries or structures 4 extend linearly, in a direction normal to the undercut, i.e., mushroom-shaped, cross-section, a plurality of linear retaining geometries or structures 4 being arranged next to one another in parallel. The container wall 1 has a barrier layer 7 in the fastening region and the heads 5 of the retaining geometries or structures 4 lie in front of the barrier layer 7, and therefore, the retaining geometries or structures 4 do not penetrate through the barrier layer 7. The fastening surface 3 of the insert part 2 lies against the fastening region of the container wall 1. The fastening surface 3 of the insert part 2 is formed over the entire surface area, that is to say does not have any openings.

The insert parts 2 to be fastened to or in the plastic container are pressed into the soft material of the container wall 1. In this respect, these insert parts 2 may have been process-dependently preheated, partially preheated, or thermally preconditioned to room temperature.

The container wall 1 must be soft enough here that the region of the component 2 to be joined that is intended for the connection can be pressed in far enough that the material displaced by the pressing-in flows into the intended regions of the connecting geometry or retaining geometry 4. This may be performed by way of being applied directly during the process or by way of local heating of the container wall 1. Various geometries, which are configured with a displacement geometry and a material inflow geometry, may be used for this purpose.

A non-detachable, permanent connection can be provided by the retaining geometry 4 being pressed and the plastic flowing back into a widening cross-section, that is to say head 5, of the retaining geometry 4.

The form-fitting connection is preferably configured such that no damage to the barrier layer 7 of the tank wall 1 occurs during the pressing-in operation. This is ensured by a suitable design of the undercut geometry and/or retaining geometry 4.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Container wall

2 Insert part

3 Fastening surface

4 Retaining geometry

5 Head

6 Foot

7 Barrier layer

What is claimed is:

1. A method for producing a plastic container having a container wall and at least one insert part having a fastening surface with a plurality of retaining geometries which protrude from the fastening surface, the method comprising:
heating the container wall at least in a fastening region thereof; and
producing a form-fit connection between the retaining geometries of the insert part and the plastic of the container wall by pressing the fastening surface of the insert part against the heated fastening region of the container wall such that the retaining geometries penetrate into the container wall without penetrating through the container wall, free ends of the retaining geometries come to lie inside the container wall, and the plastic of the container wall is arranged between the retaining geometries.

2. The method of claim 1, wherein the retaining geometries form undercuts and/or comprise form-fitting elements.

3. The method of claim 1, wherein each retaining geometry in the retaining geometries respectively comprises a head and a foot which has a cross-section that is less than a cross-section of the head.

4. The method of claim 3, wherein the retaining geometries are formed such that the heads thereof are respectively connected to the fastening surface via the feet.

5. The method of claim 1, wherein the retaining geometries are in the form of oblique ribs, arcs, elbows, hooks, or rectangles.

6. The method of claim 1, wherein the retaining geometries extend linearly, in a direction which is normal to an oblique, arcuate, angled, hook-shaped, or other undercut cross-section.

7. The method of claim 6, wherein the retaining geometries are arranged next to one another in parallel.

8. The method of claim 1, wherein:
the container wall comprises a barrier layer in the fastening region, and
the fastening surface of the insert part is pressed against the heated fastening region of the container wall such that the retaining geometries come to lie in front of the barrier layer so as to not penetrate through the barrier layer.

9. The method of claim 1, wherein the fastening surface is pressed against the heated fastening region such that the fastening surface comes to lie against the fastening region.

10. The method of claim 1, wherein the fastening surface of the insert part is formed over an entire surface area thereof.

11. A plastic container, the plastic container comprising:
a container wall; and
at least one insert part being fastened to the container wall, the at least one insert part having a fastening surface with a plurality of retaining geometries which protrude therefrom, the retaining geometries penetrating into the container wall without penetrating through the container wall such that free ends thereof lie inside the container wall, the plastic of the container wall lies between the retaining geometries, and a form-fit exists between the retaining geometries and the plastic of the container wall.

12. The plastic container of claim 11, wherein the retaining geometries form undercuts and/or form-fitting elements.

13. The plastic container of claim 11, wherein the retaining geometries are in the form of oblique ribs, arcs, elbows, hooks, or rectangles.

14. The plastic container of claim 11, wherein each retaining geometry in the retaining geometries respectively comprises a head and a foot which has a cross-section that is less than a cross-section of the head.

15. The plastic container of claim 14, wherein the heads of the retaining geometries are respectively connected to the fastening surface via the feet of the retaining geometries.

16. The plastic container of claim 11, wherein the retaining geometries extend linearly in a direction which is normal to an oblique, arcuate, angled, hook-shaped, or other undercut cross-section.

17. The plastic container of claim 16, wherein the retaining geometries are arranged next to one another in parallel.

18. The plastic container of claim 11, wherein:
the container wall comprises a barrier layer in the fastening region, and
the fastening surface of the insert part is pressed against the heated fastening region of the container wall such that the retaining geometries come to lie in front of the barrier layer so as to not penetrate through the barrier layer.

19. The plastic container of claim 11, wherein the fastening surface is pressed against the fastening region such that the fastening surface of the insert part comes to lie against the fastening region.

20. The plastic container of claim 11, wherein the fastening surface is formed over an entire surface area thereof.
